(19) United States
(12) Patent Application Publication
(10) Pub. No.: US 2004/0243927 A1
(43) Pub. Date: Dec. 2, 2004

(54) Reproducing method and apparatus for interactive mode using markup documents

(75) Inventors: Hyun-kwon Chung, Seoul (KR); Jung-kwon Heo, Seoul (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon-si (KR)

(21) Appl. No.: 10/797,057

(22) Filed: Mar. 11, 2004

Related U.S. Application Data
(63) Continuation of application No. 10/384,063, filed on Mar. 10, 2003.

(30) Foreign Application Priority Data
Mar. 9, 2002 (KR) 2002-12728
Jun. 3, 2002 (KR) 2002-31069
Nov. 12, 2002 (KR) 2002-70014

(51) Int. Cl. G06F 17/00

(52) U.S. Cl. 715/501.1

(57) ABSTRACT

A method for reproducing AV data in an interactive mode using a markup document includes dividing an operation state of a presentation engine for reproducing the markup document into a start state, a reproduction state, a pause state, and a stop state. In the reproduction state, the presentation engine performs a preloading process for reading the markup document into a memory, a loading process for interpreting the markup document and loading the markup document on a display screen, and an interacting process for facilitating an interaction between the markup document and a user

### CROSS-REFERENCE TO RELATED APPLICATIONS

This application claims priority from Korean Patent Application No. 2002-12728, filed on Mar. 9, 2002, Korean Patent Application No. 2002-31069, filed Jun. 3, 2002, and Korean Patent Application No. 2002-70014, filed Nov. 12, 2002, the contents of which are incorporated herein by reference in their entirety.

### BACKGROUND OF THE INVENTION

1. Field of the Invention

The present invention relates to reproduction of markup documents, and, more particularly, to a method and apparatus for reproducing audio/visual (AV) data in an interactive mode using markup documents.

2. Description of the Related Art

Interactive digital versatile discs (DVD), from which data can be reproduced in an interactive mode by loading them in a DVD drive installed in a personal computer (PC), are currently sold in the marketplace. An interactive DVD is a DVD on which markup documents are recorded together with audio/video (AV) data. AV data recorded on the interactive DVD can be reproduced in two ways. One is a video mode in which data is displayed as a normal DVD, and the other is an interactive mode in which reproduced AV data is displayed through a display window defined by a markup language document. If the interactive mode is selected by a user, a browser in the PC interprets and displays a markup language document recorded on the interactive DVD. AV data selected by the user is displayed in the shown display window of the markup language document.

An example of a markup language document format is extensible markup language (XML). When AV data is a movie, moving pictures are output on the display window of the XML document, and a variety of additional information such as the script and synopsis of the movie, and photographs of actors is displayed on the remaining part of the screen. The additional information includes image files or text files. In addition, the displayed markup document enables interaction. For example, if the user operates a button presented in the markup document, then a brief personal description of an actor in the moving picture being reproduced at present is displayed.

A browser is used as a markup document viewer that can interpret and display markup documents recorded on an interactive DVD. Leading browsers include MICROSOFT EXPLORER and NETSCAPE NAVIGATOR. However, because these browsers have different processes for interpreting and displaying markup documents, when an identical interactive DVD is reproduced in the interactive mode, different browsers may interpret and display the markup documents differently. In other words, display compatibility between theses browsers is not provided. Also, while a browser performs a process for reproducing a markup document (a process for interpreting and displaying the markup document), the user cannot pause the operation.

### SUMMARY OF THE INVENTION

Accordingly, it is an aspect of the present invention to provide a method and apparatus that can control a process of reproducing markup documents when AV data is reproduced in an interactive mode using the markup documents.

It is another aspect of the present invention to provide a method and apparatus which interpret and display markup documents when AV data is reproduced in an interactive mode using the markup documents, such that display compatibility is provided.

Additional aspect and advantages of the present invention will be set forth in part in the description that follows, and, in part, will be obvious from the description, or may be learned by practicing the present invention.

The foregoing and/or other aspects of the present invention are achieved by providing a method of reproducing audio/visual data in an interactive mode using a markup document, the method comprising preloading the markup document into a memory, loading the markup document on a screen, and facilitating an interaction between the markup document loaded on the screen and a user.

The method may further comprise terminating the markup document loaded on the screen. The method may further comprise discarding the markup document in the memory.

The loading of the markup document may comprise interpreting the markup document and presenting the markup document comprising the AV data on the screen.

The loading of the markup document may comprise generating a document object tree where the markup document is valid.

The generating of the document object tree may comprise determining whether the markup document is valid by performing a document type definition (DTD) check.

The generating of the document object tree may comprise generating the document object tree according to a rule that a root node of all nodes is set to a document node, a rule that all texts and elements generate nodes, and a rule that a processing instruction, a comment, and a document type generate a node.

The loading of the markup document may comprise generating a document object tree by interpreting the markup document, and rendering the markup document based on the generated document object tree. The loading of the markup document may further comprise registering an event handler in the rendering of the markup document. The loading of the markup document may further comprise monitoring whether an event takes place.

The loading of the markup document may comprise generating a document object tree by interpreting the markup document, interpreting a stylesheet and applying the interpreted stylesheet to the document object tree, generating a formatting structure based on the stylesheet-applied document object tree, and rendering the markup document based on the generated formatting structure.

The preloading of the markup document may comprise reading the markup document from one of a network and an information storage medium comprising the AV data into the memory. The preloading of the markup document may further comprise reading a stylesheet corresponding to the markup document into the memory.

The facilitating of the interaction may comprise generating a ‘load’ event. The facilitating of the interaction may comprise generating an ‘unload’ event in response to a request to terminate the markup document loaded on the screen.

The method may further comprise terminating the markup document loaded on the screen in response to an ‘unload’ event taking place during the interaction.

The above and/or other aspects of the present invention may also be achieved by providing an apparatus for reproducing audio/visual (AV) data in an interactive mode using a markup document, comprising a reader to read the AV data, a memory to temporarily store the markup document corresponding to the AV data, and a presentation engine to present the markup document according to a document life cycle, wherein the document life cycle comprises a preloading process reading the markup document into the memory, a loading process interpreting the markup document and loading the markup document on a screen, and an interacting process facilitating an interaction between the markup document and a user.

The apparatus may further comprise a buffer memory to buffer the AV data, a decoder to decode the buffered AV data, and a blender to blend the decoded AV data and the interpreted markup document, and to output the blended result.

In the apparatus, the document life cycle may further comprise a terminating process terminating the presentation of the markup document. In the apparatus, the document life cycle may further comprise a discarding process discarding the markup document in the memory.

In the loading process, the presentation engine may generate a document object tree where the markup document is valid. The presentation engine may determine whether the markup document in valid by performing a document type definition (DTD) check. In the loading process, the presentation engine may render a node of the document object tree.

In the loading process, the presentation engine may generate a document object tree by interpreting the markup document and render the markup document based on the generated document object tree. In the loading process, the presentation engine may register an event handler in the rendering of the markup document. After the rendering, the presentation engine may monitor whether an event takes place through the event handler.

In the the loading process, the presentation engine may generate a document object tree by interpreting the markup document, interpret and apply the interpreted stylesheet to the generated document object tree, generate a formatting structure based on the stylesheet-applied document object tree, and render the markup document based on the generated formatting structure.

In the apparatus, the presentation engine may generate the document object tree according to a rule that a root node of all nodes is set to a document node, a rule that all texts and elements generate nodes, and a rule that a processing instruction, a comment, and a document type generate a node.

In the preloading process, the presentation engine may read a stylesheet corresponding to the markup document into the memory. In the interacting process, the presentation engine may generate a ‘load’ event. In the interacting process, the presentation engine may generate an ‘unload’ event in response to a request to terminate the markup document loaded on the screen. In the apparatus, the presentation engine may perform a terminating process terminating the presentation of the markup document in response to the ‘unload’ event taking place during the interacting.

The markup document may be data read by the reader from an information storage medium comprising the AV data. The markup document may be data fetched from a network.

The above and/or other aspects of the present invention are further achieved by providing an apparatus for reproducing AV data recorded on an information storage medium in an interactive mode, comprising a reader to read data, which includes a markup document and a stylesheet, recorded on the information storage medium, a memory to temporarily store the markup document and the stylesheet that are read by the reader, and a presentation engine comprising a markup document parser to interpret the markup document and to generate a document object tree, a stylesheet parser to interpret the stylesheet and to generate a style rule/selector list, a script code interpreter to interpret a script code contained in the markup document, a document object model (DOM) logic unit to modify the document object tree and the style rule/selector list according to an interaction with the script code interpreter, and a layout formatter/renderer to apply the stylesheet rule/selector list to the document object tree, to generate a formatting structure based on the application of the stylesheet rule/selector list to the document object tree, and to render the markup document based on the generated formatting structure.

In the apparatus, the markup document parser may generate the document tree according to a rule that a root node of all nodes is set to a document node, a rule that all texts and elements generate nodes, and a rule that a processing instruction, a comment, and a document type generate a node.

In the apparatus, wherein the presentation engine may further comprise a markup document step controller to generate a ‘load’ event to the script code interpreter if the rendering of the markup document is completed. The markup document step controller may generate an ‘unload’ event to the script code interpreter in order to terminate a presentation of the markup document.

The apparatus may further comprise a buffer memory to buffer the AV data, a decoder to decode the buffered AV data, and a blender to blend the decoded AV data and the markup document interpreted and rendered by the presentation engine, and to output the blended result. The presentation engine may further comprises a user interface (UI) controller to receive a user input and to send the user input to the DOM logic unit and/or the layout formatter/renderer.

The above and/or other aspects of the present invention are further achieved by providing a method for reproducing audio and/or video (AV) data in an interactive mode using a markup document, the method comprising dividing an operation state of a presentation engine for reproducing the markup document into a start state, a reproduction state, a pause state, and a stop state.

The reproducing state may comprises a preloading process reading the markup document into a memory, a loading process interpreting the markup document and loading the markup document on a screen, and an interacting process facilitating an interaction between the markup document and a user. The reproduction state may further comprise a terminating process terminating the markup document loaded on the screen. The reproduction state may further comprise a discarding process discarding the markup document remaining in the memory. In the method, the presentation engine may temporarily stop the reproduction in the pause state.

In the pause state, the reproduction of markup resources may stop, a timer in the presentation engine may stop, and only events by a reproduction operation and a stop operation among user events may be selectively received. In the stop state, the reproduction of markup resources may stop, a timer in the presentation engine may stop, and information that is needed by the markup document and that is to be kept after the stop state may be stored.

The above and/or other aspects of the present invention are further achieved by providing a method of presenting a markup document in an interactive mode, the method comprising interpreting the markup document and generating a document object tree, receiving a user input and generating a first user event based on the user input, parsing a stylesheet and generating a style rule/selector list, interpreting a script code that is included in the markup document, applying the style rule/selector list to the document tree to create a document form, generating a formatting structure that corresponds to the document form or changing a formatting structure according to a second user event, rendering the markup document according to the document form, and decoding a markup resource that is linked to the markup document. The method may further comprise preloading the markup document into a memory.

The above and/or other aspects of the present invention are further achieved by providing a method of presenting a markup document in an interactive mode using a markup document, the method comprising interpreting the markup document and presenting the markup document comprising the AV data embedded therein on a screen, and facilitating an interaction between the markup document and a user thereby allowing the user to pulse and/or stop the presentation of the markup document.

### BRIEF DESCRIPTION OF THE DRAWINGS

These and/or other aspects and advantages of the present invention will become apparent and more readily appreciated from the following description of the preferred embodiments, taken in conjunction with the accompanying drawings of which:

FIG. 1 is a schematic diagram of an interactive DVD on which AV data is recorded;

FIG. 2 is a schematic diagram of a volume space in the interactive DVD of FIG. 1;

FIG. 3 is a diagram showing the directory structure of an interactive DVD;

FIG. 4 is a schematic diagram of a reproducing system according to an embodiment of the present invention;

FIG. 5 is a functional block diagram of a reproducing apparatus according to an embodiment of the present invention;

FIG. 6 is a diagram of an example of the presentation engine of FIG. 5;

FIG. 7 is a diagram showing an example of a markup document;

FIG. 8 is a diagram of a document object tree generated based on the markup document of FIG. 7;

FIG. 9 is a diagram of an example of a remote controller;

FIG. 10 is a state diagram showing each state of a presentation engine and the relations between the states. The states and relations between the states are defined to reproduce a markup document;

FIG. 11 is a diagram showing a document life cycle in a reproduction state of FIG. 10;

FIGS. 12A through 12D are a series of flowcharts of the process performed by a reproducing method according to an embodiment of the present invention; and

FIG. 13 is a flowchart of the process performed by a reproducing method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein the reference numerals refer to like elements throughout.

FIG. 1 is a schematic diagram of an interactive DVD on which AV data is recorded.

Referring to FIG. 1, in the tracks of an interactive DVD 100, AV data is recorded as moving pictures expert group (MPEG) bitstreams and a plurality of markup documents are recorded. Here, the markup documents indicate any documents, to which source codes that are written in JAVASCRIPT language or JAVA language are linked or inserted, as well as those documents that are written in markup languages such as hyper text markup language (HTML) and XML. In other words, the markup documents act as an application that is needed when AV data is reproduced in the interactive mode. Meanwhile, image files, animation files, text files, and sound files that are linked to and embedded into a markup document and are reproduced are referred to as ‘markup resources.’

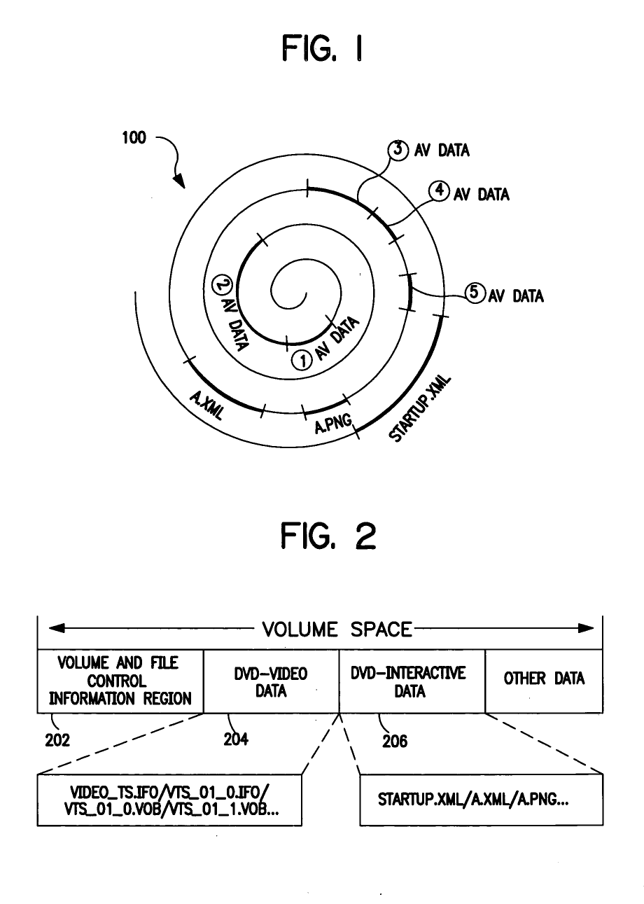

FIG. 2 is a schematic diagram of a volume space in the interactive DVD 100 of FIG. 1.

Referring to FIG. 2, the volume space of the interactive DVD 100 comprises a volume and file control information region 202 in which volume and file control information is recorded, a DVD-Video data region 204 in which video title data corresponding to the control information is recorded, and a DVD-lnteractive data region 206 in which data that is needed in order to reproduce AV data in an interactive mode is recorded.

The DVD-Video data region 204, VIDEO_TS.IFO that has reproduction control information of all the included video titles and VTS_01_0.IFO that has reproduction control information of a first video title are first recorded and then VTS_01_0.VOB, VTS_01_1.VOB, . . . , which are AV data forming video titles, are recorded. VTS_01_0.VOB, VTS_01_.VOB, . . . , are video titles, that is, video objects (VOBs). Each VOB contains video object units (VOBUs) in which navigation packs, video packs, and audio packs are packed. The structure is disclosed in more detail in a draft standard for DVD-Video, “DVD-Video for Read Only Memory Disc 1.0,” which was published in August, 1996.

DVD_ENAV.IFO, which has reproduction control information of all interactive information, a start document STARTUP.XML, a markup document file A.XML, and a graphic file A.PNG, which is a markup resource to be inserted into A.XML and displayed, are recorded in the DVD-Interactive data region 206. Other markup documents and markup resource files having a variety of formats that are inserted into the markup documents may also be recorded.

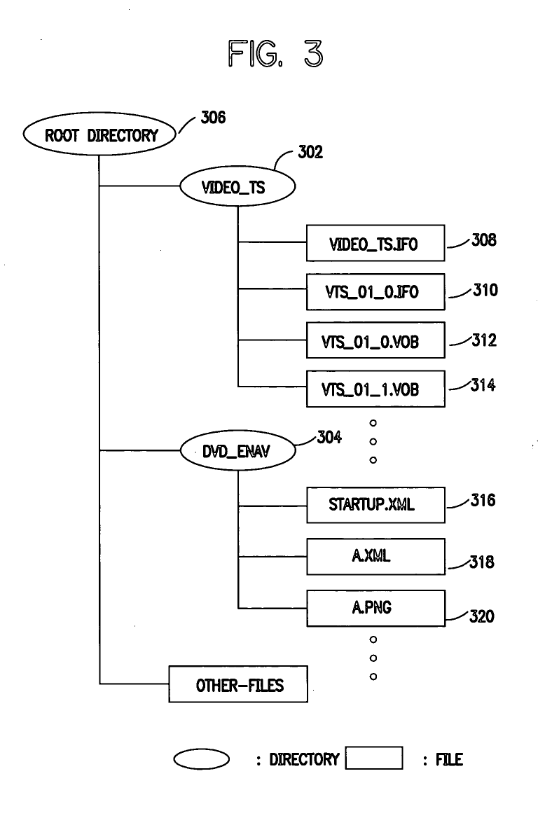

FIG. 3 is a diagram showing the directory structure of the interactive DVD 100.

Referring to FIG. 3, a DVD video directory VIDEO_TS 302 and a DVD interactive directory DVD_ENAV 304 in which interactive data is recorded are prepared in the root directory 306. In addition, other files may be prepared in the root directory 306.

VIDEO_TS.IFO 308, VTS_01_0.IFO 310, VTS_01_0.VOB 312, VTS_01_1.VOB 314, . . . , which are explained in reference to FIG. 2, are stored in the VIDEO_TS 302. STARTUP.XML 316, A.XML 318, and A.PNG 320, which are explained in reference to FIG. 2, are stored in the DVD_ENAV 304.

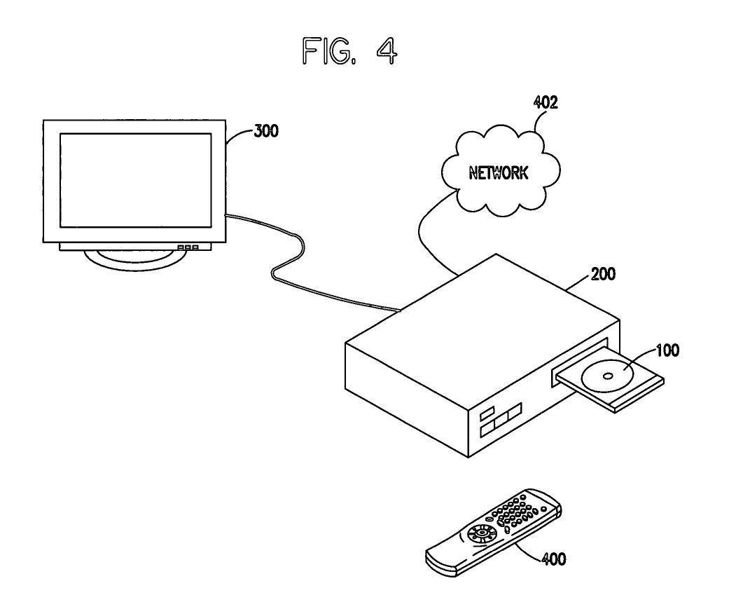

FIG. 4 is a schematic diagram of a reproducing system according to an embodiment of the present invention.

Referring to FIG. 4, the reproducing system comprises a reproducing apparatus 200 to reproduce the interactive DVD 100, a display apparatus 300, which is a television in an embodiment, and a remote controller 400. The remote controller 400 receives a control command from the user and transmits the command to the reproducing apparatus 200, via for example, an infrared signal. The reproducing apparatus 200 has a DVD drive which reads data recorded on the interactive DVD 100. If the DVD 100 is placed in the DVD drive of the reproducing apparatus 200 and the user selects the interactive mode, then the reproducing apparatus 200 reproduces desired AV data in the interactive mode by using a markup document corresponding to the interactive mode, and sends the reproduced AV data to the display apparatus 300. AV scenes of the reproduced AV data and a markup scene from the markup document are displayed together on the display apparatus 300. The “interactive mode” is a reproducing mode in which AV data is displayed as AV scenes in a display window defined by a markup document, that is, a reproducing mode in which AV scenes are embedded in a markup scene and then displayed. Here, the AV scenes are scenes that are displayed on the display apparatus 300 when the AV data is reproduced, and the markup scene is a scene that is displayed on the display apparatus 300 when the markup document is parsed. Meanwhile, the “video mode” indicates a conventional DVD-Video reproducing method, by which only AV scenes that are obtained by reproducing the AV data are displayed. In an embodiment, the reproducing apparatus 200 supports both the interactive mode and video mode. In addition, the reproducing apparatus 300 may transmit or receive data, for example, markup documents, after being connected to a network 402, such as the Internet.

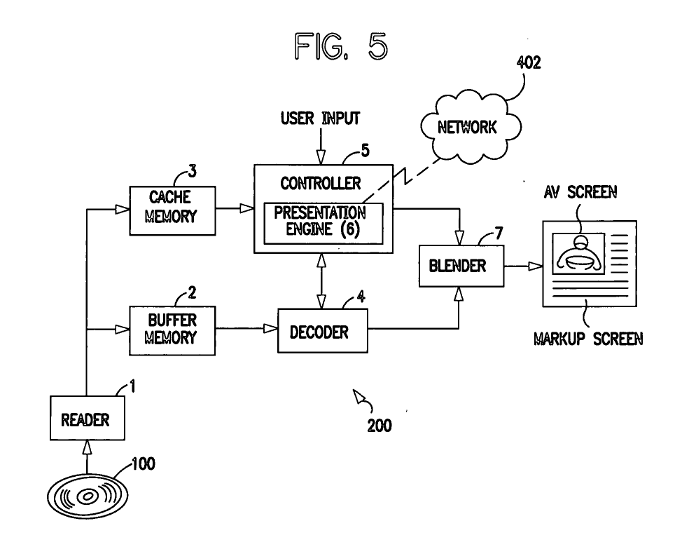

FIG. 5 is a functional block diagram of the reproducing apparatus 200 according to an embodiment of the present invention.

Referring to FIG. 5, the reproducing apparatus 200 comprises a reader 1, a buffer memory 2, a cache memory 3, a controller 5, a decoder 4, and a blender 7. A presentation engine 6 is included in the controller 5. The reader 1 has an optical pickup (not shown) which reads data, for example, by shining a laser beam on the DVD 100.

The reader 1 controls the optical pickup according to a control signal from the controller 5 such that the reader reads AV data and markup documents from the DVD 100.

The buffer memory 2 buffers AV data. The cache memory 3 is used for temporarily storing a reproduction control information file for controlling reproduction of AV data and/or markup documents recorded on the DVD 100, or other needed information.

In response to a user's selection, the controller 5 controls the reader 1, the presentation engine 6, the decoder 4, and the blender 7 so that the AV data recorded on the DVD 100 is reproduced in the video mode or in the interactive mode.

The presentation engine 6, which is part of the controller 5, is an interpretation engine that interprets and executes markup languages and client interpretation program languages, for example, JAVASCRIPT and JAVA. In addition, the presentation engine 6 may further include a variety of plug-in functions. The plug-in function enables markup resource files to be opened in a variety of formats, which are included in or linked to a markup document. That is, the presentation engine 6 functions as a markup document viewer. Also, in an embodiment, the presentation engine 6 may be connected to network 402 and read and fetch predetermined data.

In the interactive mode, the presentation engine 6 fetches a markup document stored in the cache memory 3, interprets the document, and performs rendering. The blender 7 blends an AV data stream and the rendered markup document such that the AV data stream is displayed in a display window defined by the markup document, i.e., the AV scene is embedded in the markup scene. Then, the blender 7 outputs the blended scene to the display apparatus 300.

In a process for reproducing (that is, interpreting and displaying) a markup document according to an embodiment of the present invention, the presentation engine 6 defines a start state in which operations for a start of reproduction are performed, a reproduction state in which a markup document is executed, a pause state in which the reproduction of the markup document is temporarily stopped, and a stop state in which the reproduction of the markup document is stopped, and operates based on the defined states. The start state indicates a state in which the presentation engine 6 performs operations for initialization. The operations of the presentation engine 6 in the reproduction state, pause state, and stop state are determined by a user event that is generated by the remote controller 400 according to a user input, and a script code that is written in the markup document. This will be explained later in more detail.

In addition, according to an embodiment of the present invention, the presentation engine 6 presents a markup document in the reproduction state, based on a document life cycle which comprises a preloading process in which the markup document is read and stored in the cache memory 3, a loading process in which the markup document that is read by the reader 1 is interpreted and loaded on the screen, an interacting process in which interaction between the markup document loaded on the screen and the user is performed, a terminating process in which the markup document loaded on the screen is terminated, and a discarding process in which the markup document remaining in the cache memory 3 is deleted.

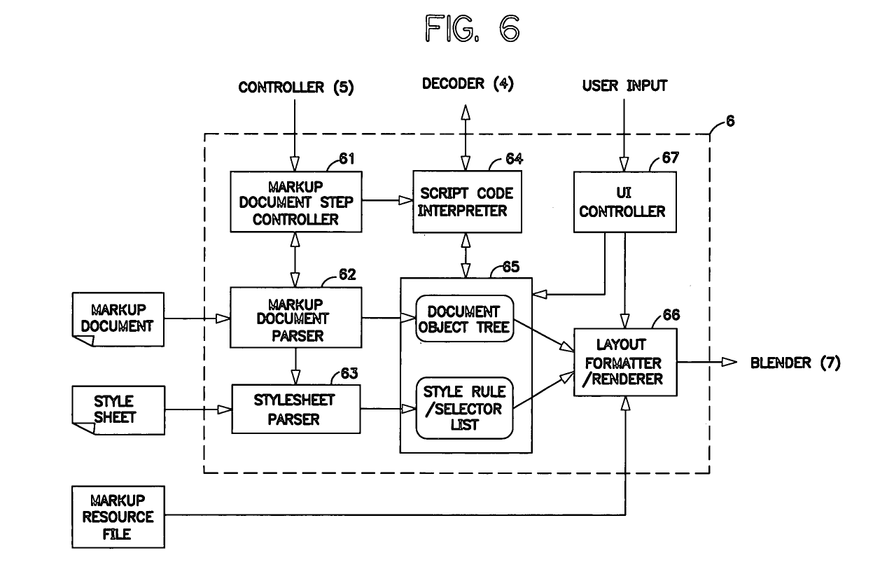

FIG. 6 is a diagram of an example of the presentation engine of FIG. 5.

Referring to FIG. 6, the presentation engine 6 comprises a markup document step controller 61, a markup document parser 62, a stylesheet parser 63, a script code interpreter 64, a document object model (DOM) logic unit 65, a layout formatter/renderer 66, and a user interface (UI) controller 67.

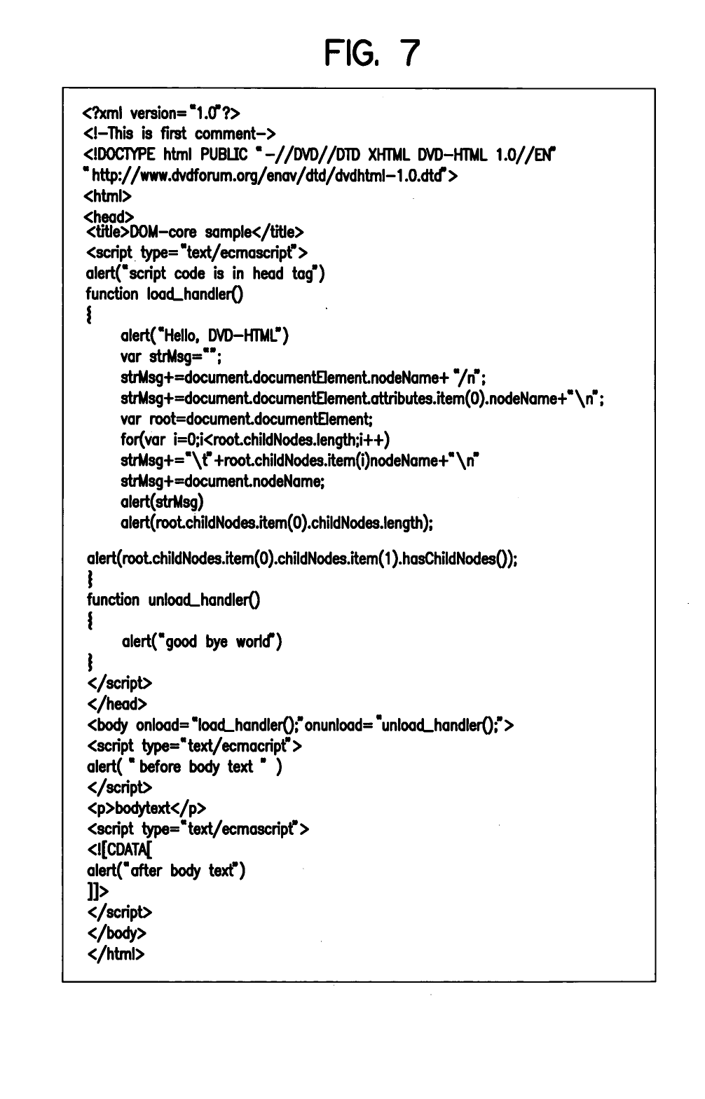

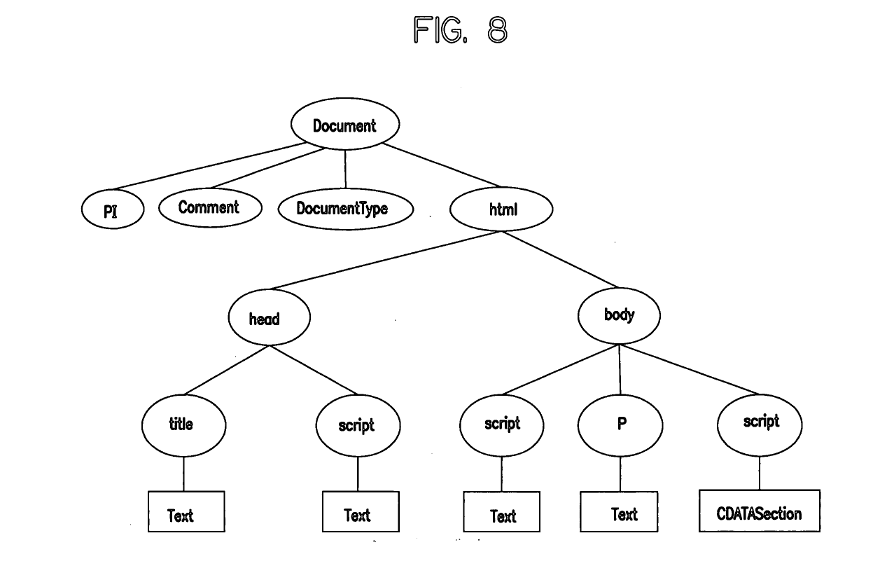

The markup document parser 62 interprets a markup document and generates a document object tree. The rules for generating a document object tree are as follows. First, a root node of all nodes is set as a document node. Secondly, all texts and elements generate nodes. Thirdly, a processing instruction, a comment, and a document type generate a node. FIG. 7 is a diagram showing an example of a markup document. FIG. 8 is a diagram of a document object tree generated based on the markup document of FIG. 7. Thus, according to an aspect of the present invention, an identical document object tree is generated for an identical markup document.

The UI controller 67 receives a user input through the remote controller 400, and sends the user input to the DOM logic unit 65 and/or the layout formatter/renderer 66. That is, the UI controller 67 generates a user event according to an aspect of the present invention.

The stylesheet parser 63 parses a stylesheet and generates a style rule/selector list. The stylesheet enables the form of a markup document to be freely set. In the present embodiment, the syntax and form of a stylesheet comply with the cascading style sheet (CSS) processing model of the World Wide Web Consortium (W3C), which was published on Dec. 17, 1996. The script code interpreter 64 interprets a script code included in the markup document. With the DOM logic unit 65, the markup document can be made into a program object or can be modified. That is, the document object tree and the style rule/selector list are modified or improved according to the interaction with the script code interpreter 64, or a user event from the UI controller 67. The layout formatter/renderer 66 applies the style rule/selector list to a document object tree, and according to a document form (for example, whether the form is a printed page or sound) that is output based on the applying, generates a formatting structure corresponding to the form, or changes a formatting structure according to a user event from the UI controller 67. Though the formatting structure looks like a document object tree at first glance, the formatting structure may use a pseudo-element and does not necessarily have a tree structure. That is, the formatting structure is dependent on implementation. Also, the formatting structure may have more information than a document object tree has or may have less information. For example, if an element of a document object tree has a value “none” as an attribute value of “display”, the element does not generate any value for a formatting structure. Because the formatting structure of the present embodiment complies with a CSS2 processing model, a more detailed explanation is available in the CSS2 processing model, which was published on May 12, 1998. The layout formatter/renderer 66 renders a markup document according to the form of a document (that is, a target medium) that is output based on the generated formatting structure, and outputs the result to the blender 7. For the rendering, the layout formatter/renderer 66 may comprise a decoder for interpreting and outputting an image or sound. In this manner, the layout formatter/renderer 66 decodes a markup resource linked to the markup document and outputs the markup resource to the blender 7.

The markup document step controller 61 controls processing so that interpretation of a markup document is performed according to the document life cycle described above. Also, if the rendering of a markup document is finished, the markup document step controller 61 generates a ‘load’ event to the script code interpreter 64, and in order to terminate a presentation of a markup document, generates an ‘unload’ event to the script code interpreter 64.

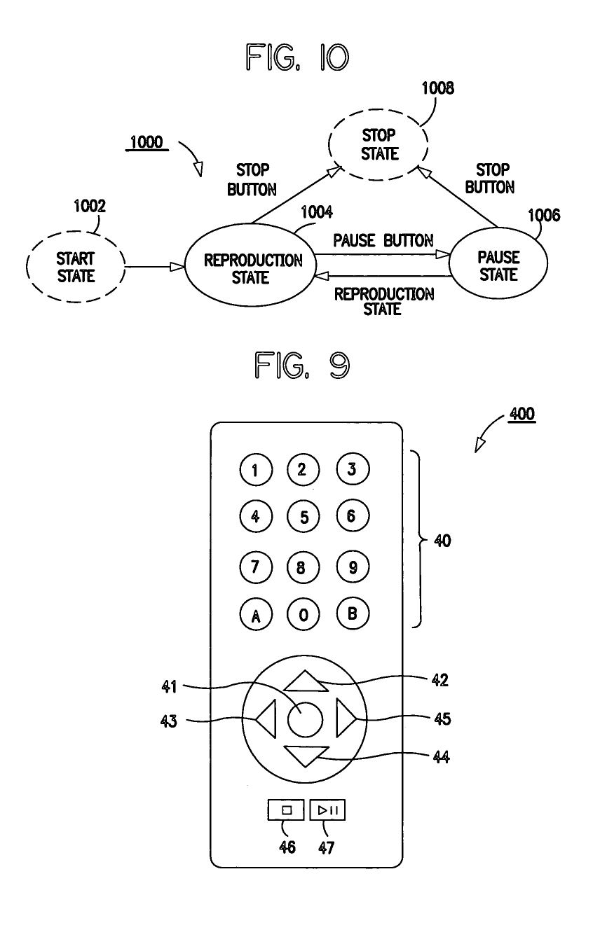

FIG. 9 is a diagram of an example of a remote controller.

Referring to FIG. 9, in an embodiment, a group of numerical buttons and special character buttons 40 is arranged at one end of the front surface of the remote controller 400. At the center of the front surface, a direction key 42 for moving a pointer displayed on the screen of the display apparatus 300 upward, a direction key 44 for moving the pointer downward, a direction key 43 for moving the pointer to the left, and a direction key 45 for moving the pointer to the right are arranged, and an enter key 41 is arranged at the center of the direction keys. At the other end of the front surface, a stop button 46 and a reproduction/pause button 47 are arranged. The reproduction/pause button 47 is prepared as a toggle type such that whenever the user operates the button 48, the reproduction function and pause function are selected alternately. According to an embodiment of the present invention, the user can control the reproduction process of a markup document by the presentation engine 6, by operating the stop button 46 and reproduction/pause button 47 in the interactive mode.

However, embodiments of the present invention are not so limited, as any combination or layout of buttons of remote controller 400 may be used. In addition, a different type of switch may be used for the stop button 46 and the reproduction/pause button 47, for example, a non-toggle switch, where each button may be operated independently from the other.

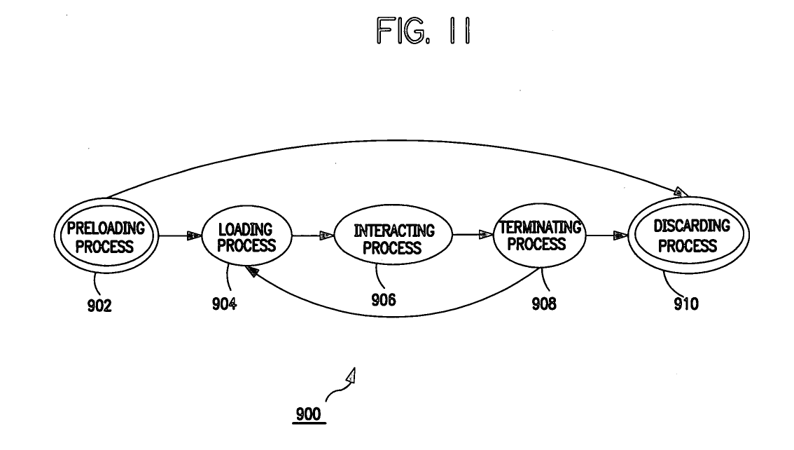

FIG. 10 is a state diagram showing each state of the presentation engine 6 and the relations between the states, the states and relations that are defined to reproduce a markup document.

Referring to FIG. 10, the states 1000 of the presentation engine 6 are broken down into a start state 1002, a reproduction state 1004, a pause state 1006, and a stop state 1008. In the start state 1002, if there is a DVD 100 in the reproducing apparatus 200, the presentation engine 6 performs initialization operations such as reading and fetching disc information, or loading a file system to the cache memory 3. An initialization sub-state (not illustrated) is achieved inside the reproducing apparatus and is not recognized by the user. If the initialization operations are completed, the state of the presentation engine 6 is changed to the reproduction state 1004. In the reproduction state 1004, the presentation engine 6 reproduces a markup document that is specified as a start document. If the user operates the reproduction/pause button 47 on the remote controller 400, the state of the presentation engine 6 is changed to the pause state 1006. Pause of reproduction of a markup document means a pause of reproduction of markup resources that are linked to the markup document and displayed on the markup scene. For example, in a case where a flash animation is embedded in the markup scene and is being displayed, the motion of the flash animation stops during the pause state 1006. If the user operates the reproduction/pause button 47 again, the state of the presentation engine 6 is changed to the reproduction state 1004 and the reproduction of the markup document begins again. That is, the reproduction of the markup resources displayed on the markup scene begins again from the point at which reproduction of the markup resources stopped. The state of the presentation engine 6 alternates between the reproduction state 1004 and the pause state 1006 when the reproduction/pause button 47 is operated. Meanwhile, if the user operates the stop button 46 in the pause state 1006 or the reproduction state 1004, the state of the presentation engine 6 is changed to the stop state 1008 where the reproduction of the markup document stops completely. In the stop state 1008, the reproduction of markup resources displayed on the markup stops completely. Accordingly, if the user operates the reproduction/pause button 47 again, reproduction begins again from the first part of the markup resources.

The operations of the presentation engine 6 in the start state 1002, the reproduction state 1004, the pause state 1006, and the stop state 1008 are determined by user events that are generated by the remote controller 400 according to a user input, and script codes written in the markup document. Accordingly, by changing the user events and script codes written in the markup document, the operations of the presentation engine 6 in respective states 1000 may be changed in a variety of ways.

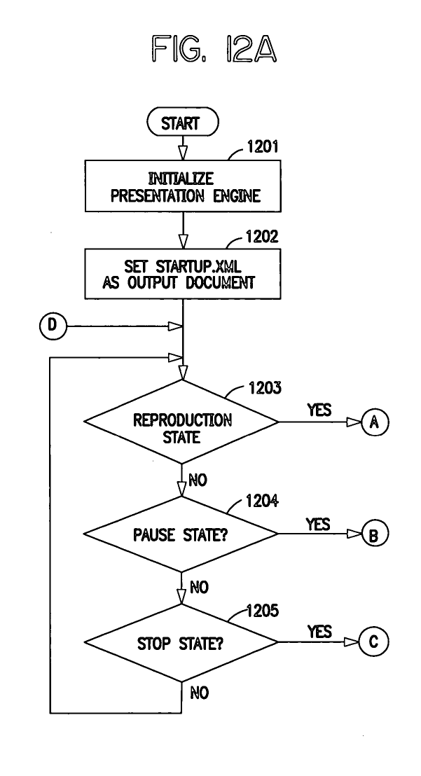

FIG. 11 is a diagram showing a document life cycle in a reproduction state of FIG. 10 according to an embodiment of the present invention.

Referring to FIG. 11, the document life cycle 900 comprises a preloading process 902, a loading process 904, an interacting process 906, a terminating process 908, and a discarding process 910. All markup documents go through the document life cycle 900. However, in an embodiment, some markup documents may go through a document life cycle 900 in which the discarding process 910 immediately follows the preloading process 902. A case where a markup document is stored in the cache memory 3 and then deleted without being presented (displayed) corresponds to this cycle. Also, there may be a document life cycle in which the loading process 904 is performed again after the terminating process 908. A case where a markup document whose presentation thereof has been terminated is being presented again corresponds to this cycle.

The preloading process 902 ends in a process in which a markup document (and a stylesheet) is read into the cache memory 3. That is, a resource related to the markup document is generated as an on-memory item.

The loading process 904 includes processes for interpreting the markup document and presenting the markup document on the display screen. That is, the “loading” in the loading process 904 refers to the markup document being loaded on the screen. The interpreting of the markup document indicates a process for performing a syntax check for checking whether the syntax of a code is correct and a document type definition (DTD) check for checking whether or not there is a semantic error, and if there is no error, generating a document object tree. A markup document without an error is said to be “valid.” Also, the interpreting includes a process for interpreting a stylesheet which exists separately from the markup document or is included in the markup document.

For an XML document, the syntax checking process includes checking whether XML elements are properly arranged. That is, it is checked whether tags that are XML elements are tested in accordance with the syntax. A detailed explanation of the syntax check is available in the XML standard, which was published on Oct. 6, 2000. The DTD is information on document rules accompanying a markup document and distinguishes tags of the document, identifies attribute information set to tags, and indicates how values appropriate to the attribute information are set. In the DTD checking process, a semantic error of the markup document is found based on the DTD. The rules that are applied to a process for generating a document object tree according to the present invention are the same as described above.

In brief, the loading process 904 includes the process for interpreting the markup document and generating a document object tree, and the process for rendering the markup document based on the generated document object tree. More specifically, in the loading process 904, a document object tree is generated by interpreting the markup document, a style rule/selector list is generated by interpreting the stylesheet, the generated style rule/selector list is applied to the document object tree, a formatting structure is generated based on the type of list applied, and the markup document is rendered based on the formatting structure.

In the interacting process 906, the displayed content of a document changes, for example, by an interaction with the user when the user operates a button of a document loaded on the screen or scrolls the screen, or by an interaction between the decoder 4 and the presentation engine 6, or by a process in which the user operates a button on the remote controller 400 to control the reproduction of the markup document. In the interacting process 906, the markup document presented on the screen receives a load event from the markup document step controller 61. If the screen displays another markup document shifting away from the currently loaded markup document, an unload event is generated. If the user operates a button on the remote controller 400, a user input event is sent to the script code interpreter 64 through the UI controller 67 and the DOM controller 65. At that time, it is determined whether to reflect an event in the presentation engine 6 after an event handler script code that is provided to the DOM controller 65 is executed in the script code interpreter 64. Then, if it is determined to reflect the event in the presentation engine 6, the event is reflected and processed in the presentation engine 6 to perform a predefined operation. For example, when any one of the reproduction/pause button 47 and the stop button 46 that control the execution states of the reproducing apparatus is operated, the operation for navigating elements forming the markup documents such as the direction keys 42 through 45 and the enter key 41 corresponds to this. If the user does not want to reflect the event, the user can use a function, for example, event.preventDefault( ), which is provided by the WC3. Detailed information is described in Document Object Model (DOM) Level 2 Events Specification version 1.0, which was published on Nov. 13, 2000.

The terminating process 908 indicates a state where the presentation of a markup document is terminated and the markup document remains in the cache memory 3.

In the discarding process 910, the markup document whose presentation is terminated is deleted from the cache memory 3. That is, in the discarding process 910, the on-memory item information is deleted.

Based on the structure described above, a reproduction method according to the present invention will now be explained.

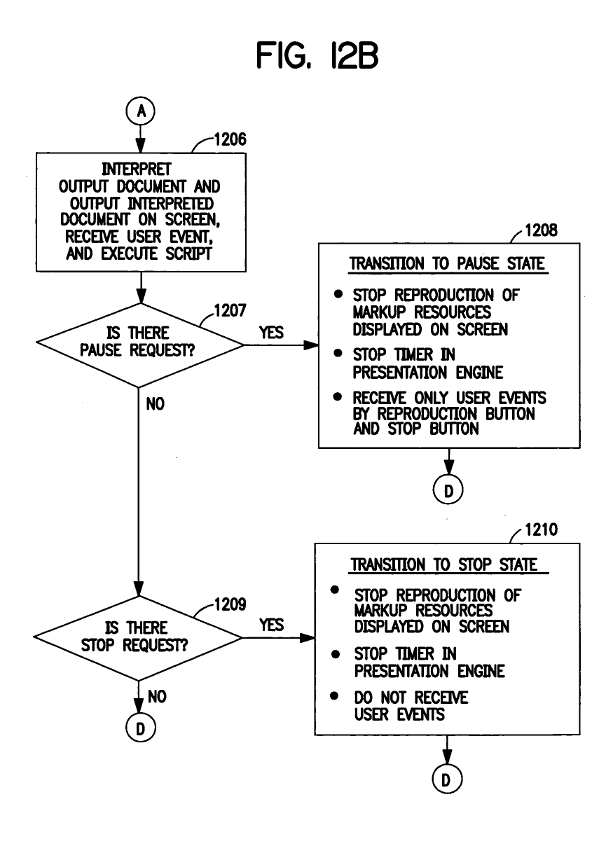

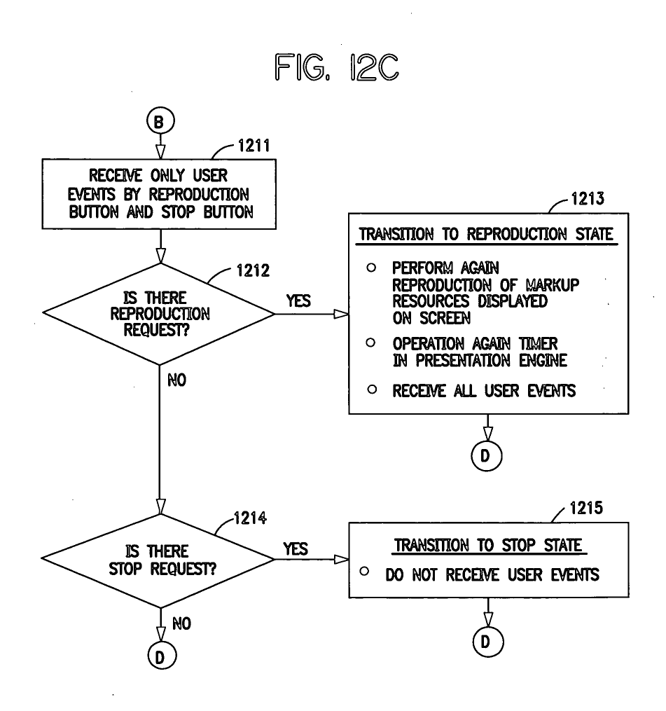

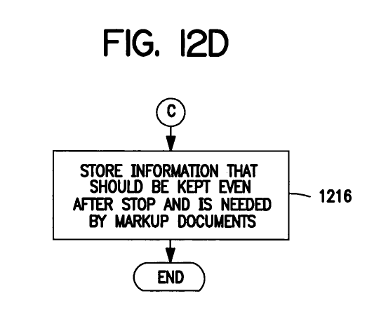

FIGS. 12A through 12D are a series of flowcharts of the process performed by a reproducing method according to an embodiment of the present invention.

Referring to FIG. 12A, if there is a DVD 100 in the reproducing apparatus 200, the reproducing apparatus initializes the presentation engine 6 at 1201, and sets STARTUP.XML as an output document at 1202. Based on the user input event that is generated when a user input button is operated, the presentation engine 6 determines the current state. If the current state is a reproduction state at 1203, A is performed, if it is a pause state at 1204, B is performed, and if it is a stop state at 1205, C is performed.

Referring to FIG. 12B, if the current state is a reproduction state (A), the presentation engine 6 interprets and displays on the screen STARTUP.XML, which is set to the output document, receives a user event from the user input, and executes a script corresponding to the user event, the script which is written in or linked to the markup document at 1206. If there is a pause request from the user, that is, if the user operates the reproduction/pause button 47 at 1207, the state is changed to the pause state at 1208. In the pause state, the reproduction of markup resources that are displayed on the screen stops, and a timer that is needed in interpreting markup documents and in decoding markup resources in the presentation engine 6 stops. In the pause state, only user events corresponding to the reproduction/pause button 47 and stop button 46 are received. If there is a stop request from the user, that is, if the user pushes the stop button 47 at 1209, the state is changed to the stop state at 1210. In the stop state, the presentation engine 6 completely stops the reproduction of markup resources that are displayed on the screen, completely stops the timer, and does not receive any user events.

Referring to FIG. 12C, in the pause state (B), if the user operates the reproduction/pause button 47 or the stop button 46, the presentation engine 6 receives a user event corresponding to the button at 1211. That is, if there is a reproduction request from the user, that is, if the user operates the reproduction/pause button 47 at 1212, the state is changed to the reproduction state at 1213. In the reproduction state, the presentation engine 6 begins reproduction of the markup resources displayed on the screen from a part where the reproduction stopped temporarily, begins the timer from a part where the timer stopped, and receives all user events. If there is a stop request from the user, that is, if the user operates the stop button 46 at 1214, the state is changed to the stop state at 1215. In the stop state, the presentation engine 6 does not receive any user events.

Referring to FIG. 12D, in the stop state (C), the presentation engine 6 stores information that should be kept even after the stop and is needed by markup documents, in a non-volatile memory (not shown) at 1216.

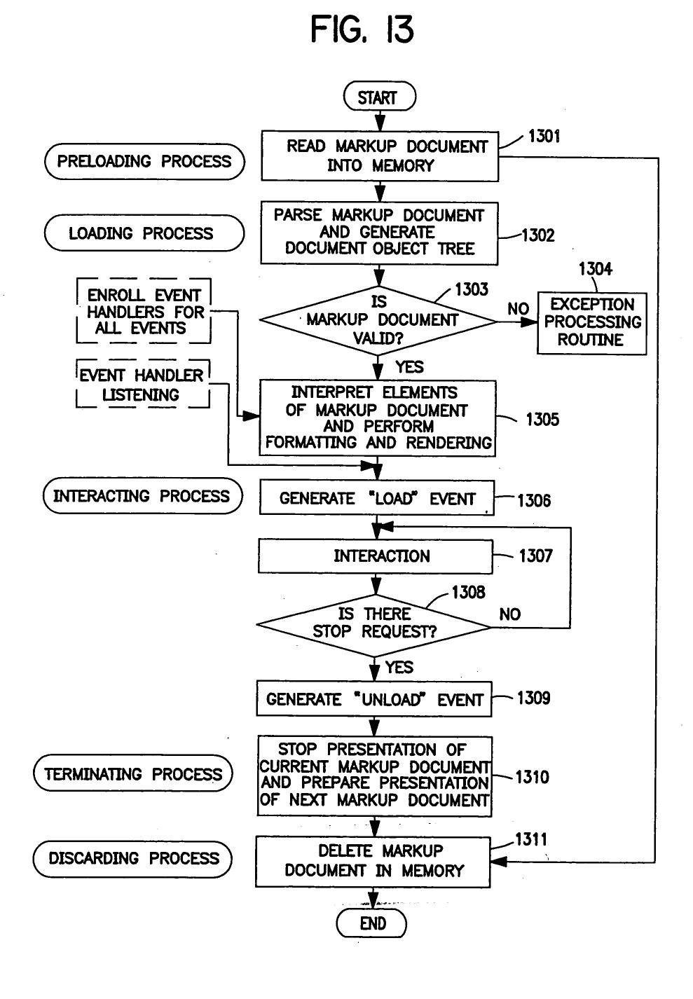

FIG. 13 is a flowchart of the process performed by a reproducing method according to an embodiment of the present invention.

FIG. 13 shows processes for processing a markup document in each state of the document life cycle 900. That is, in the preloading process 902, the presentation engine 6 of the reproducing apparatus 200 reads a markup document into the cache memory 3 at 1301. In the loading process 904, the presentation engine 6 parses the markup document and generates a document object tree at 1302. If the markup document is not valid and a document object tree is not generated at 1303, an exception processing routine is performed at 1304. If the markup document is valid and a document object tree is normally generated at 1303, the elements of the markup document are interpreted and formatting and rendering are performed at 1305. Meanwhile, while the rendering is performed, event handlers for all kinds of events are enrolled in the script code interpreter 64. Event handlers monitor whether an enrolled event is generated. If the markup document is rendered and corresponding AV data is decoded, the blender 7 blends the rendered markup document with decoded AV data streams, and outputs the result on the screen . In the interacting process 906, the corresponding markup document is loaded on the screen, and the presentation engine 6 generates a “load” event to the script code interpreter 64 such that jobs to be performed in relation to the event may be processed at 1306. Then, interaction with the user is performed through the markup document at 1307. Here, if there is a request to stop the presentation of the corresponding markup document at 1308, the presentation engine 6 generates an “unload” event to the script code interpreter 64 at 1309. Then, in the terminating process 908, presentation of the current markup document is stopped and presentation of the next markup document is prepared at 1310. In the discarding process 910, the markup document is deleted from the cache memory 3 at 1311. As described above, there may be a markup document in which the discarding operation follows immediately after the preloading operation. That is, a discarding process 910 may follow immediately after a preloading process 902.

As described above, when AV data is reproduced in an interactive mode, a document cycle of a markup document is defined, and according to the defined document cycle, the markup document is interpreted and executed. Accordingly, compatibility of screen output is provided. In addition, a user may stop or temporarily stop the execution of the markup document.

The hardware included in the system may include memories, processors, and/or Application Specific Integrated Circuits (“ASICs”). Such memory may include a machine- readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it would be appreciated by those skilled in the art that changes may be made in these embodiments without departing from the principles and spirit of the present invention, the scope of which is defined in the claims and their equivalents.

What is claimed is:

1. A method of producing audio and/or video (AV) data in an interactive mode using a markup document, the method comprising dividing an operation state of a presentation engine for reproducing the markup document into a start state, a reproduction state, a pause state, and a stop state.

2. The method according to claim 1, wherein the reproducing state comprises:
a preloading process reading the markup document into a memory;
a loading process interpreting the markup document and loading the markup document on a screen; and
an interacting process facilitating an interaction between the markup document and a user.

3. The method according to claim 2, wherein the reproduction state further comprises a terminating process terminating the markup document loaded on the screen.

4. The method according to claim 2, wherein the reproduction state further comprises a discarding process discarding the markup document remaining in the memory.

5. The method according to claim 1, wherein the presentation engine temporarily stops the reproduction in the pause state.

6. The method according to claim 1, wherein in the pause state, the reproduction of markup resources stops, a timer in the presentation engine stops, and only events by a reproduction operation and a stop operation among user events are selectively received.

7. The method according to claim 1, wherein in the stop state, the reproduction of markup resources stops, a timer in the presentation engine stops, and information that is needed by the markup document and that is to be kept after the stop state is stored.

8. A method of presenting a markup document in an interactive mode, the method comprising:
interpreting the markup document and generating a document object tree;
receiving a user input and generating a first user event based on the user input;
parsing a stylesheet and generating a style rule/selector list;
interpreting a script code that is included in the markup document;
applying the style rule/selector list to the document tree to create a document form;
generating a formatting structure that corresponds to the document form or changing a formatting structure according to a second user event;
rendering the markup document according to the document form; and
decoding a markup resource that is linked to the markup document.

9. The method according to claim 8, wherein a root node of all nodes of the document tree is set as a document node, wherein all texts and elements generate nodes, and wherein a processing instruction, a comment, and a document type generate a node.

10. The method according to claim 8, further comprising preloading the markup document into a memory.

11. A method of reproducing audio and/or visual (AV) data in an interactive mode using a markup document, the method comprising:
interpreting the markup document and presenting the markup document comprising the AV data embedded therein on a screen; and
facilitating an interaction between the markup document and a user thereby allowing the user to pulse and/or stop the presentation of the markup document.

12. A computer-readable medium comprising computer-executable instructions for performing the operations recited in claim 1.

13. A computer-readable medium comprising computer-executable instructions for performing the operations recited in claim 2.

14. A computer-readable medium comprising computer-executable instructions for performing the operations recited in claim 8.

15. A computer-readable medium comprising computer-executable instructions for performing the operations recited in claim 11.
